(19) United States
(12) Patent Application Publication
(10) Pub. No.: US 2019/0085830 A1
(43) Pub. Date: Mar. 21, 2019

(54) WIND TURBINE

(71) Applicant: Siemens Gamesa Renewable Energy A/S, Brande (DK)

(72) Inventors: Niels Karl Frydendal, Herning (DK); Troels Kanstrup, Rask Moelle (DK); Dennis Olesen, Aarhus (DK); Kim Thomsen, Skorping (DK); Morten Thorhauge, Aarhus (DK)

(21) Appl. No.: 16/132,529

(22) Filed: Sep. 17, 2018

(30) Foreign Application Priority Data
Sep. 20, 2017 (EP) 17192101.8

(51) Int. Cl. F03D 80/70; F03D 3/00; F03D 13/20

(52) U.S. Cl. CPC F03D 80/70; F05B 2240/50; F03D 13/20; F03D 3/002

(57) ABSTRACT

Provided is a wind turbine, including a hub, a shaft which is connected to the hub, a bearing housing, in which the shaft is supported rotatable, a fluid bearing which supports the shaft in the bearing housing, wherein the fluid bearing is arranged at a proximal end of the shaft, wherein the proximal end of the shaft is positioned proximal to the hub, and a roller bearing which also supports the shaft in the bearing housing, wherein the roller bearing is arranged at a distal end of the shaft, and wherein the distal end of the shaft is positioned distal to the hub. One advantage of the wind turbine is that compared to roller bearings, the fluid bearing provides a bearing type with high load capacity and scalability to even large wind turbines.

### CROSS-REFERENCE TO RELATED APPLICATIONS

This application claims priority to European application No. 17192101.8 having a filing date of Sep. 20, 2017 the entire contents of which are hereby incorporated by reference.

### FIELD OF TECHNOLOGY

The following relates to a wind turbine.

### BACKGROUND

Modern wind turbine rotor blades are built from fiber-reinforced plastics. A rotor blade typically comprises an airfoil having a rounded leading edge and a sharp trailing edge. The rotor blade is connected with its blade root to a hub of the wind turbine. The increasing size of wind turbines and the trend towards offshore turbines puts high demands on serviceability and robustness of the bearings of a shaft of the wind turbine. Also due to fact that large wind turbines have large dynamic shaft deflections, high loads and low speeds makes it challenging for bearings to work and last the demanded lifetime. Conventional wind turbine designs using roller bearings or ball bearings for carrying a drive train, a generator on direct drive wind turbines and the hub with blades require external crane capacity if a main bearing needs replacement. This type of service is very costly, especially for wind turbines located offshore.

### SUMMARY

An aspect relates to an improved wind turbine.

Accordingly, a wind turbine is provided. The wind turbine comprises a hub, a shaft which is connected to the hub, a bearing housing, in which the shaft is supported rotatable, a fluid bearing which supports the shaft in the bearing housing, wherein the fluid bearing is arranged at a proximal end of the shaft, wherein the proximal end of the shaft is positioned proximal to the hub, and a roller bearing which also supports the shaft in the bearing housing, wherein the roller bearing is arranged at a distal end of the shaft, and wherein the distal end of the shaft is positioned distal to the hub.

The fluid bearing provides a bearing type with high load capacity and scalability to even large wind turbines. The fluid bearing is also easy to make exchangeable in-situ if a segmented bearing is used. The combination of the fluid bearing at an upwind location of the shaft and the roller bearing at a downwind location of the shaft is a cost effective and low weight solution. The higher loaded fluid bearing can be easily exchanged when it is segmented. A cost effective and light turbine structure can be provided that allows for in-situ replacement of all main bearings. No crane or crane vessel is needed to replace the main bearings.

The position where the fluid bearing is arranged can be named upwind position or upwind location. The fluid bearing can therefore be named proximal bearing, proximal main bearing, upwind bearing or upwind main bearing. The position where the roller bearing is arranged can be named downwind position or downwind location. The roller bearing can therefore be named distal bearing, distal main bearing, downwind bearing or downwind main bearing. The proximal end of the shaft can be named first end, and the distal end of the shaft can be named second end. “Proximal” means close to the hub and “distal” means away from the hub, i.e. not close to the hub.

A shaft arrangement of the wind turbine comprises the bearing housing, the shaft, the roller bearing and the fluid bearing. A roller bearing, rolling-element bearing or rolling bearing preferably is a bearing which carries a load by placing rolling elements (such as balls or rollers) between two bearing rings called races. The relative motion of the races causes the rolling elements to roll with very little rolling resistance and with little sliding. The shaft can be rotated in the bearing housing around an axis or rotation axis. The wind turbine further comprises blades that are connected to the hub.

Fluid bearings or fluid film bearings are bearings in which the load is supported by a thin layer of rapidly moving pressurized liquid or gas between the bearing surfaces. Since there is no contact between the moving parts, there is no sliding friction, allowing fluid bearings to have lower friction, wear and vibration than many other types of bearings. Fluid bearings can be broadly classified into two types: Fluid dynamic bearings (also known as hydrodynamic bearings) and hydrostatic bearings. Hydrostatic bearings are externally pressurized fluid bearings, where the fluid is usually oil, water or air, and the pressurization is done by a pump. Hydrodynamic bearings rely on the high speed of the journal (the part of the shaft resting on the fluid) to pressurize the fluid in a wedge between the faces. Preferably, the fluid bearing is a hydrostatic bearing.

According to an embodiment, the fluid bearing is segmented. This means, the fluid bearing has a bearing surface that is divided into a variety of segments. These segments can be changed individually.

According to a further embodiment, the fluid bearing is a tilting pad bearing. A tilting pad bearing has sectional shoes, or pads on pivots. When the tilting pad bearing is in operation, the rotating part of the tilting pad bearing carries fresh oil into the pad area through viscous drag. Fluid pressure causes the pad to tilt slightly, creating a narrow constriction between the shoe and the other bearing surface. A wedge of pressurized fluid builds behind this constriction, separating the moving parts. The tilt of the pad adaptively changes with bearing load and speed. Various design details ensure continued replenishment of the oil to avoid overheating and pad damage.

According to a further embodiment, the roller bearing is a double row tapered roller bearing in X-configuration, a spherical roller bearing, a double row tapered roller bearing or a triple row cylindrical roller bearing. In case of a double row tapered roller bearing in X-configuration this means that the roller bearing has two rows of tapered rollers. These two rows are arranged in such a way that a rotation axis of the tapered rollers are arranged in a X-position. However, any other type of roller bearing can be used.

According to a further embodiment, the fluid bearing takes only loads that act in a radial direction of the shaft. The radial direction is arranged perpendicular to the rotation axis of the shaft. The fluid bearing cannot take loads that act in an axial direction of the shaft.

According to a further embodiment, the roller bearing takes loads that act in a radial direction of the shaft and loads that act in an axial direction of the shaft. The loads that act in the axial direction can be named axial loads. The loads that act in the radial direction can be named radial loads. The axial direction is positioned parallel to the axis of the shaft.

According to a further embodiment, a diameter of the fluid bearing is bigger than a diameter of the roller bearing. The roller bearing is usually lighter loaded compared to the fluid bearing. The fluid bearing typically sees very high radial loads due to the weight of the hub and the blades. The roller bearing is subjected to lighter loads and therefore it is easier to manufacture within known roller bearing know-how and size constraints.

According to a further embodiment the shaft is hollow. Therefore, a weight reduction can be achieved. Alternatively, the shaft can be solid. The shaft preferably is arranged inside the bearing housing.

According to a further embodiment, the wind turbine further comprises a generator, wherein the generator is mounted to the proximal end of the shaft. This means, the generator is mounted close to the fluid bearing. When the generator is mounted at the upwind location of the shaft, the roller bearing at the downwind location can be dismounted and replaced in-situ because the distal end of the shaft is free. In other words, nothing is mounted to the distal end of the shaft. This type of wind turbine can be called direct drive wind turbine.

According to a further embodiment, the generator is mounted to a proximal end of the bearing housing. This means, the generator is mounted to the proximal end of the shaft as well as to the proximal end of the bearing housing.

According to a further embodiment, the generator is mounted to a proximal flange of the shaft and to a proximal flange of the bearing housing. For example, the proximal flange of the bearing housing can be connected to a stator of the generator and the proximal flange of the shaft can be connected to a rotor of the generator or vice versa.

According to a further embodiment, the wind turbine further comprises a generator, wherein the generator is mounted to the distal end of the shaft. This means, the generator is mounted close to the roller bearing. A gearbox can also be mounted to the distal end of the shaft.

According to a further embodiment, the wind turbine further comprises a tower, wherein the bearing housing is connected to the tower. The bearing housing preferably can be rotated relative to the tower. The bearing housing can be arranged inside a nacelle. The bearing housing can be part of the nacelle.

According to a further embodiment, the shaft is shaped conical, wherein the shaft narrows from its proximal end towards its distal end. Preferably, the shaft has the shape of a truncated cone. A diameter of the shaft gradually reduces from the proximal end towards the distal end.

According to a further embodiment, the bearing house is made of one piece. Preferably, the bearing housing is a cast part. The bearing housing can also be a combined unit. In particular, the bearing housing can comprise two separate units or could even be an integrated part of a gearbox.

“Wind turbine” presently refers to an apparatus converting the wind's kinetic energy into rotational energy, which may again be converted to electrical energy by the apparatus.

Further possible implementations or alternative solutions of embodiments of the invention also encompass combinations—that are not explicitly mentioned herein—of features described above or below with regard to the embodiments. The person skilled in the art may also add individual or isolated aspects and features to the most basic form of embodiments of the invention.

### BRIEF DESCRIPTION

Some of the embodiments will be described in detail, with references to the following figures, wherein like designations denote like members, wherein:

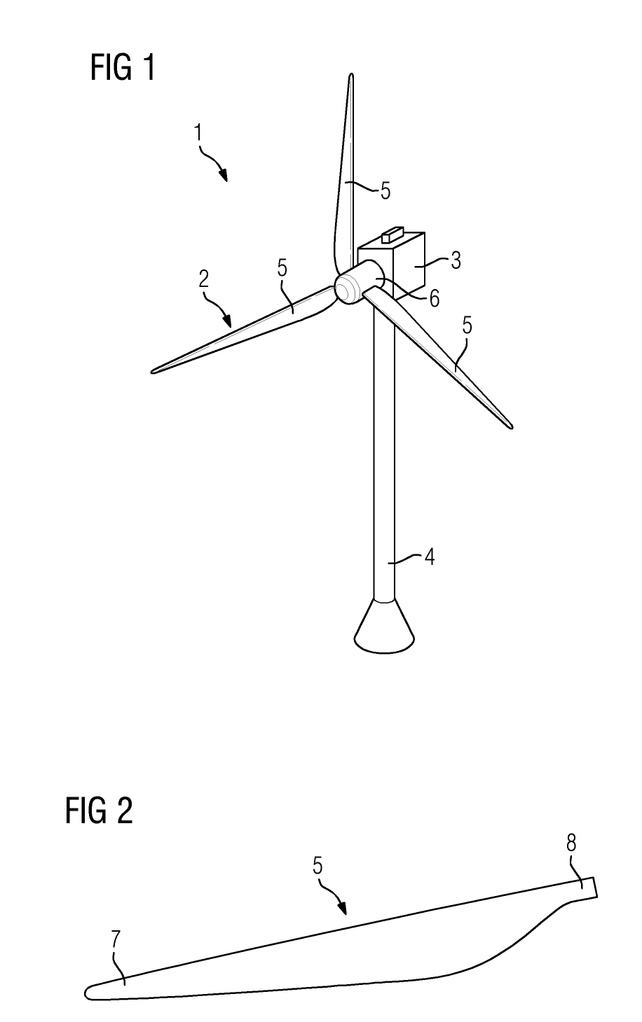

FIG. 1 is a perspective view of a wind turbine according to an embodiment;

FIG. 2 is a perspective view of a wind turbine rotor blade according to an embodiment;

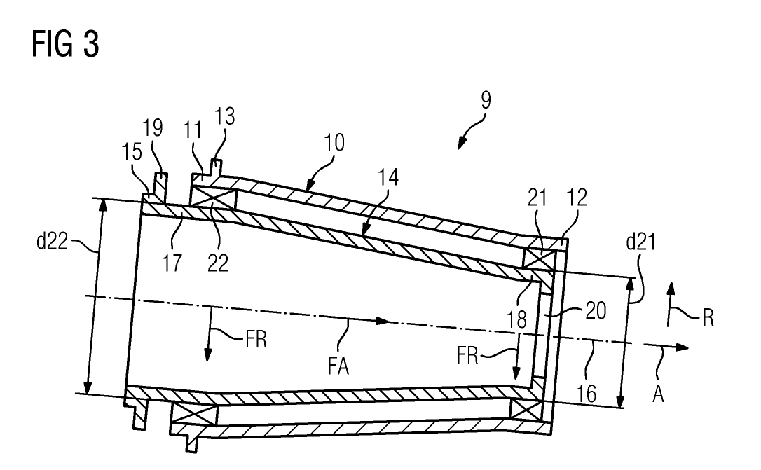

FIG. 3 shows a sectional view of a shaft arrangement according to an embodiment; and

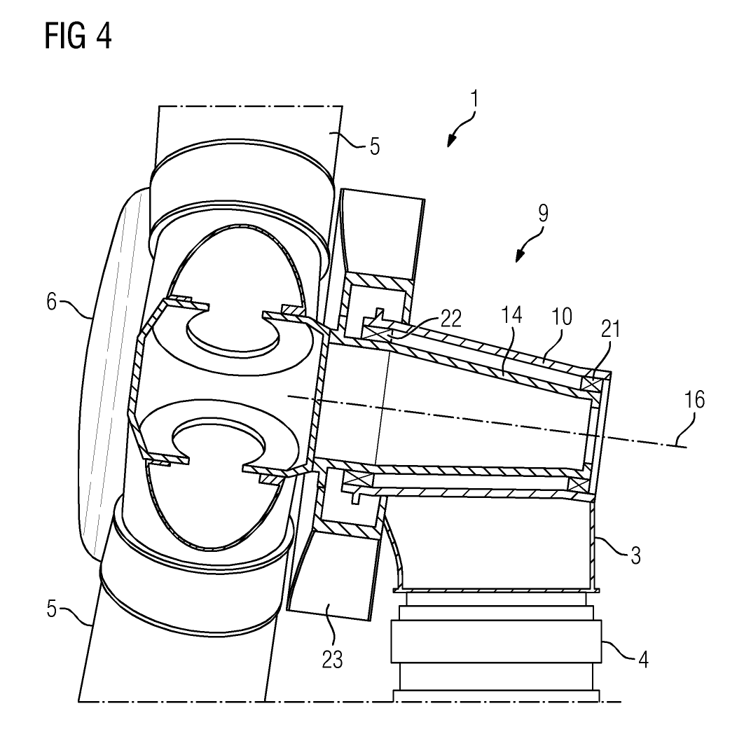

FIG. 4 shows a perspective sectional view of the wind turbine according to FIG. 1.

### DETAILED DESCRIPTION

In the Figures, like reference numerals designate like or functionally equivalent elements, unless otherwise indicated.

FIG. 1 shows a wind turbine 1 according to one embodiment.

The wind turbine 1 comprises a rotor 2 connected to a generator (not shown) arranged inside a nacelle 3. The nacelle 3 is arranged at the upper end of a tower 4 of the wind turbine 1.

The rotor 2 comprises three rotor blades 5. The rotor blades 5 are connected to a hub 6 of the wind turbine 1. Rotors 2 of this kind may have diameters ranging from, for example, 30 to 160 meters or even more. The rotor blades 5 are subjected to high wind loads. At the same time, the rotor blades 5 need to be lightweight. For these reasons, rotor blades 5 in modern wind turbines 1 are manufactured from fiber-reinforced composite materials. Therein, glass fibers are generally preferred over carbon fibers for cost reasons. Oftentimes, glass fibers in the form of unidirectional fiber mats are used.

FIG. 2 shows a rotor blade 5 according to one embodiment.

The rotor blade 5 comprises an aerodynamically designed portion 7, which is shaped for optimum exploitation of the wind energy and a blade root 8 for connecting the rotor blade 5 to the hub 6.

FIG. 3 shows a shaft arrangement 9 according to one embodiment.

The shaft arrangement 9 is arranged inside the nacelle 3 and/or is part of the nacelle 3. The shaft arrangement 9 is arranged to support the hub 6 rotatable. The shaft arrangement 9 comprises a bearing housing 10. The bearing housing 10 can be a combined unit. Furthermore, the bearing housing could also comprise two separate units or could even be an integrated part of a gearbox (not shown). The bearing housing 10 is hollow and comprises a first end or proximal end 11 which is arranged close or proximal to the hub 6 (not shown in FIG. 3). The bearing housing 10 also comprises a second end or distal end 12 which is arranged away from the hub 6 or distal to the hub 6. The bearing housing 10 further comprises a flange 13 for mounting a generator (not shown) to the bearing housing 10. The flange 13 can be named as first generator flange or proximal flange.

The shaft arrangement 9 further comprises a hub shaft, main shaft or shaft 14 which is connected to the hub 6. The hub 6 can be connected to the shaft 14 by means of screws and/or bolts. The shaft 14 has a flange 15 for connecting the shaft 14 to the hub 6. The flange 15 can be named as hub flange or first flange of the shaft 14. The shaft 14 is supported rotatable in the bearing housing 10. This means, the shaft can be rotated relative to the bearing housing 10 around a rotating axis 16. The shaft 14 is shown as a big thin walled construction. It could also be a traditional shaft, as for any wind turbine 1 with two main bearings and a shaft.

The shaft 14 has a first end or proximal end 17. The proximal end 17 is arranged close or proximal to the hub 6. In particular, the proximal end 17 of the shaft 14 is positioned at the proximal end 11 of the bearing housing 10. The shaft 14 also has a second end or distal end 18. The distal end 18 is arranged away from or distal to the hub 6. In particular, the distal end 18 of the shaft 14 is positioned at the distal end 12 of the bearing housing 10.

As can be seen from FIG. 3, the shaft 14 is hollow. The shaft 14 has a flange 19 for mounting the afore-mentioned generator to the shaft 14. The flange 19 can be named as proximal flange, second generator flange or second flange of the shaft 14. For example, the flange 13 of the bearing housing 10 can be connected to a stator of the generator and the flange 19 of the shaft 14 can be connected to a rotor of the generator or vice versa. The shaft 14 also has a flange 20 for gearbox or generator mount. The flange 20 can be named as distal flange or third flange of the shaft 14.

The shaft arrangement 9 has a roller bearing 21 which supports the shaft 14 in the bearing housing 10 at the distal end 12 of the bearing housing 10 and the distal end 18 of the shaft 14. The location where the roller bearing 21 is arranged can be named as downwind location. A roller bearing, rolling-element bearing or rolling bearing is a bearing which carries a load by placing rolling elements (such as balls or rollers) between two bearing rings called races. The relative motion of the races causes the rolling elements to roll with very little rolling resistance and with little sliding. The roller bearing 21 can be named as first bearing, downwind bearing, downwind main bearing or distal bearing because it is arranged distal to the hub 6. The roller bearing 21 has an inner diameter d21.

The roller bearing 21 is arranged to take loads FA, FR both in an axial direction A and in a radial direction R of the shaft 14. The roller bearing 21 can be any type of roller bearing, for example a spherical roller bearing, a double row tapered roller bearing, a triple row cylindrical roller bearing or the like. The preferred bearing type for the roller bearing 21 is a double row tapered roller bearing in X-configuration because this bearing type has little resistance towards shaft bending and high radial load capacity as well as sufficient axial load capacity. But any combination of roller or ball bearing can be used to support the shaft 14 at the distal end 18 thereof.

The shaft arrangement 9 also has a fluid film bearing or fluid bearing 22 which supports the shaft 14 in the bearing housing 10 at the proximal end 11 of the bearing housing 10 and the proximal end 17 of the shaft 14. The location where the fluid bearing 22 is arranged can be named as upwind location. The fluid bearing 22 can be named as second bearing, upwind bearing, upwind main bearing or proximal bearing because it is arranged proximal to the hub 6. The fluid bearing 22 is arranged to take only loads FR in the radial direction R but not in the axial direction A of the shaft 14. The fluid bearing 22 has an inner diameter d22. The inner diameter d22 of the fluid bearing 22 is bigger than the inner diameter d21 of the roller bearing 21.

Fluid bearings are bearings in which the load is supported by a thin layer of rapidly moving pressurized liquid or gas between the bearing surfaces. Since there is no contact between the moving parts, there is no sliding friction, allowing fluid bearings to have lower friction, wear and vibration than many other types of bearings. Fluid bearings can be broadly classified into two types: Fluid dynamic bearings (also known as hydrodynamic bearings) and hydrostatic bearings. Hydrostatic bearings are externally pressurized fluid bearings, where the fluid is usually oil, water or air, and the pressurization is done by a pump. Hydrodynamic bearings rely on the high speed of the journal (the part of the shaft resting on the fluid) to pressurize the fluid in a wedge between the faces.

Preferably, the fluid bearing 22 is a hydrostatic bearing. In particular, the fluid bearing 22 is segmented so that the bearing components can be replaced in-situ. This means, without disassembly of the shaft arrangement 9 and/or the wind turbine 1. Preferably, the fluid bearing 22 is a tilting pad bearing. A tilting pad bearing has sectional shoes, or pads on pivots. When the tilting pad bearing is in operation, the rotating part of the tilting pad bearing carries fresh oil in to the pad area through viscous drag. Fluid pressure causes the pad to tilt slightly, creating a narrow constriction between the shoe and the other bearing surface. A wedge of pressurized fluid builds behind this constriction, separating the moving parts. The tilt of the pad adaptively changes with bearing load and speed. Various design details ensure continued replenishment of the oil to avoid overheating and pad damage.

To use the roller bearing 21 instead of a second fluid bearing is a very cost-effective solution that would otherwise require two separate fluid film bearings to replace the roller bearing 21. Namely a first bearing for radial loads and a second bearing for axial loads and another fluid film bearing at the upwind location. This means, in total three bearings. The roller bearing 21 is usually lighter loaded compared to the fluid bearing 22. The fluid bearing 22 typically sees very high radial load FR due to the weight of the hub 6 and the rotor blades 5. The roller bearing 21 is loaded lighter and therefore it is easier to manufacture within known roller bearing know-how and size constraints.

FIG. 4 shows a detail view of the wind turbine 1 according to FIG. 1.

As can be seen from FIG. 4, a generator 23 is mounted to the flanges 13, 19 of the bearing housing 10 and the shaft 14. The configuration of FIG. 4, wherein the generator 23 is mounted at the upwind location of the shaft 14, the roller bearing 21 at the downwind location can be dismounted and replaced in-situ because the distal end 18 of the shaft 14 is free. In other words, nothing is mounted to the distal end 18 of the shaft 14. As can be seen from FIG. 4, the bearing housing 10 is mounted to the tower 4.

However, the shaft arrangement 9 can also be used with a traditional geared wind turbine (not shown). In this case, it is more labor-intensive to replace the roller bearing 21 because the gearbox is mounted next to the roller bearing 21 at the flange 20 of the shaft 14.

An alternative realization (not shown) is that the roller bearing 21 is an integrated part of the gearbox. In this case, the roller bearing 21 would be replaced together with the gearbox and the fluid bearing 22 would be replaced by exchanging the segments on site. It is also possible to use fluid bearings both at the upwind and at the downwind location. This, however, involves higher mass and also more complex structure.

The wind turbine 1 with the shaft arrangement 9 has the following advantages. The fluid bearing 22 provides a bearing type with high load capacity and scalability to even large wind turbines. The fluid bearing 22 is also easy to make exchangeable in-situ if a segmented or tilting pad bearing is used. However, to realize both a thrust bearing and a radial bearing it requires a construction that can be realized lighter and cheaper with a single double row tapered roller bearing 21. This roller bearing 21 can be used and still maintain the possibility to exchange all bearing parts in-situ.

The combination of the fluid bearing 22 at the upwind location, where segmentation is preferred to perform in-situ replacement, and the roller bearing 21 at the downwind location is a cost effective and low weight solution. The higher loaded fluid bearing 22 can be easily exchanged when it is segmented or a tilting pad bearing. A cost effective and light turbine structure can be provided that allows for in-situ replacement of all main bearings 21, 22.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A wind turbine comprising:
a hub;
a shaft which is connected to the hub;
a bearing housing, in which the shaft is rotatably supported;
a fluid bearing which supports the shaft in the bearing housing, wherein the fluid bearing is arranged at a proximal end of the shaft, wherein the proximal end of the shaft is positioned proximal to the hub; and
a roller bearing which also supports the shaft in the bearing housing, wherein the roller bearing is arranged at a distal end of the shaft, and wherein the distal end of the shaft is positioned distal to the hub.

2. The wind turbine according to claim 1, wherein the fluid bearing is segmented.

3. The wind turbine according to claim 1, wherein the fluid bearing is a tilting pad bearing.

4. The wind turbine according to claim 1, wherein the roller bearing is at least one of: a double row tapered roller bearing in X-configuration, a spherical roller bearing, a double row tapered roller bearing, and a triple row cylindrical roller bearing.

5. The wind turbine according to claim 1, wherein the fluid bearing takes only loads that act in a radial direction of the shaft.

6. The wind turbine according to claim 1, wherein the roller bearing takes loads that act in a radial direction of the shaft and loads that act in an axial direction of the shaft.

7. The wind turbine according to claim 1, wherein a diameter of the fluid bearing is bigger than a diameter of the roller bearing.

8. The wind turbine according to claim 1, wherein the shaft is hollow.

9. The wind turbine according to claim 1, further comprising a generator mounted to the proximal end of the shaft.

10. The wind turbine according to claim 9, wherein the generator is mounted to a proximal end of the bearing housing.

11. The wind turbine according to claim 10, wherein the generator is mounted to a proximal flange of the shaft and to a proximal flange of the bearing housing.

12. The wind turbine according to claim 1, further comprising a generator mounted to the distal end of the shaft.

13. The wind turbine according to claim 1, further comprising a tower, wherein the bearing housing is connected to the tower.

14. The wind turbine according to claim 1, wherein the shaft is shaped conical, and wherein the shaft narrows from the proximal end of the shaft towards the distal end of the shaft.

15. The wind turbine according to claim 1, wherein the bearing house is made of one piece.
